(19) United States
(12) Patent Application Publication
(10) Pub. No.: US 2011/0213873 A1
(43) Pub. Date: Sep. 1, 2011

(54) Method and Arrangement for Improved Session Setup Signaling Policing

(75) Inventor: Ingemar Johansson, Lulea (SE)

(73) Assignee: TELEFONAKTIEBOLAGET LM ERICSSON (PUBL), Stockholm (SE)

(21) Appl. No.: 13/125,477

(22) PCT Filed: Jan. 9, 2009
(86) PCT No.: PCT/SE2009/050009

§ 371 Date: Apr. 21, 2011

Related U.S. Application Data
(60) Provisional application No. 61/108,383, filed on Oct. 24, 2008.

(51) Int. Cl. G06F 15/173

(52) U.S. Cl. 709/223

(57) ABSTRACT

In an improved method in a control node managing media sessions between nodes in a telecommunication network, exchanging S10 at least one media session description message between two nodes, and determining S20 if the one message comprises at least one option tag, said at least one option tag indicating potential configurations for said media session. Subsequently, comparing S30 the at least one option tag to a set of network supported option tags, said network supported option tags indicating supported configurations for said network, and modifying S40 the media session initiation message based on the comparison.

### TECHNICAL FIELD

The present invention relates to session management in communication systems in general, and specifically to policing of session setup signaling in such systems.

### BACKGROUND

In relation to exchange of streaming multimedia content in a session between two or more parties in a communication system, the so called Session Description Protocol (SDP) [4] is a protocol that describes the media (for instance audio, video) in such a session. It is intended for describing multimedia communication sessions for the purpose of session announcement, session invitation and other forms of multimedia session initiation. SDP does not provide the content of the media form itself but simply provides a negotiation between two end points to allow them to agree on a media type and format. Examples of what is described are the codecs that are to be used and the bitrates and possibly also if the media is going in both directions (bidirectional) or just in one direction (unidirectional). The SDP is commonly included in the body of a SIP INVITE. SIP (Session Initiation Protocol) [5] is the stack protocols that makes sure that for instance ring back and busy tones in a telecommunication system are generated and that it is possible to e.g. redirect a call.

The SDP was initially intended to describe only unidirectional flows; however, it has been extended to handle bidirectional flows as well. Offer/answer is a typical mechanism used within SDP, the main idea is that a user agent (UA) that initiates a call offers an SDP (carried in a SIP-INVITE message) with a set of different media options and recommended codecs for each media. The UA that receives the SDP offer returns the preferred codec configuration in another SIP message in the reverse direction. Once this offer/answer exchange is done, the session starts and media will flow between the two participants (agents) in the session.

An SDP or SDP message typically consists of two parts.
A session level description part that gives a general description of the session with contact information and start/stop time. Parameters and attributes on the session levels have effect on all the media level descriptions.
A media level description part with zero or more media descriptions. Each media description defines a media (for instance audio or video). Parameters on the media level apply to only one media description.

The use of SDP is not without problems. Typical problems with conventional SDP's as they will be referred to in this text is that it is not possible to describe a session that offers different transport formats or codecs with different bitrates without the need of repeating almost similar media descriptions. The result being a bulky session description that easily becomes ambiguous.

The so-called and recently developed SDP Capability Negotiation framework (SDPCapNeg [1]) is a framework for SDP offer/answer in the IETF MMUSIC WG. The role of SDPCapNeg is to solve most of the issues with SDP and still be able to be backwards compatible with conventional SDP.

The core SDPCapNeg framework makes it possible to propose e.g. different transport formats for a given media without the need to specify several media descriptions with almost the same contents (a described before a severe limitation with conventional SDP).

The SDPCapNeg framework supports addition of extensions; these extensions are identified by so-called option tags in the SDP. One extension is media capabilities (SDPMedCapNeg) [2] identified by the option tag “med-v0” that makes it possible to propose e.g. different codec options with different bitrate requirements, something that is not possible with conventional SDP.

The SDPCapNeg framework introduces a number of capability attributes (attribute names tcap and acap) and the possibility to specify a number of potential configurations (attribute name pcfg) that references the capability attributes. The SDPMedCapNeg adds more capability attributes and also the concept of latent configurations that makes it possible to do capabilities exchange for media and do the actual session setup at a later stage.

The potential with SDPCapNeg may introduce a few problems in an IMS environment. One serious issue is that, as the framework supports extensions, there is a risk that extensions that are unsupported in the network gets introduced in the session setup negotiation by user agents. The problem is elevated by the fact that the SDPCapNeg framework can hide these extensions from an intermediary node that does not understand the extensions.

There is therefore a need for means by which to ensure that the use of unsupported extensions does not result in ambiguous or incomprehensible SDP messages.

### SUMMARY

An aspect of the present invention is to provide methods and arrangements to provide improved management of extensions in SDP or similar messages in telecommunication systems.

A basic aspect of the present invention discloses an improved method in a control node managing media sessions between nodes in a telecommunication network. Initially, exchanging S10 a media session description message between two nodes and determining S20 if the message comprises at least one option tag. The option tag indicates potential configurations for the media session. Subsequently, comparing S30 the option tag to a set of network supported option tags indicating supported configurations for the network. Finally, modifying S40 the media session initiation message based on the comparison.

Advantages of the present invention include
Avoiding Uncontrolled additions of SDPCapNeg extensions made by UA.
Clear rules on how to deal with extensions, thus causing fewer problematic error cases.
Reduced risk of ambiguous SDPCapNeg potential configurations.
Reduced need to signal supported SDPCapNeg extensions to each UA at SIP-REGISTER.

### BRIEF DESCRIPTION OF THE DRAWINGS

The invention, together with further objects and advantages thereof, may best be understood by making reference to the following description taken together with the accompanying drawings, in which:

FIG. 1 is an illustration of a system in which the present invention can be implemented;

FIG. 2 is a schematic flow chart of an embodiment of a method according to the present invention.

FIG. 3 is a schematic flow chart of a further embodiment of a method according to the present invention;

FIG. 4 is an illustration of an embodiment of an arrangement according to the present invention.

### ABBREVIATIONS

CSCF Call Session Control Function
Conventional SDP SDP that does not use SDPCapNeg or its extensions
IP Mobility Subsystem
SAP Session Announcement Protocol
SDPCapNeg SDP Capability Negotiation (framework)
SDPMedCapNeg SDP Media Capability Negotiation (extension)
SGB Session Border Gateway
SGC Session Border Controller
SDP Session Description Protocol
SIP Session Initiation Protocol
UA User Agent

### DETAILED DESCRIPTION

To further improve the understanding of the framework in which the present invention has evolved, some of the specific problems with prior art will be discussed below. In addition, a few key concepts and parts of a system in which the present invention can be beneficial will be described.

The previously mentioned SDP is a format for describing streaming media initialization parameters in an ASCII string (or similar). It can be used with a number of transport protocols, such as SIP, HTTP and others. However, for the present invention it will be described in the context of SIP. It is intended for describing multimedia communication sessions for the purpose of session announcement, session invitation and other forms of multimedia session initiation. SDP does not provide the content of the media form itself but simply provides a negotiation between two end points to allow them to agree on a media type and format. This allows SDP to support upcoming media type and formats, enabling systems based on this technology to be forward compatible. There are in essence five terms closely related to and viewed as key aspects of the SDP stack, namely:
Conference: It is a set of two or more communication users along with the software they are using.
Session: Session is the media sender and receiver and the flowing stream of data.
Session announcement: A session announcement is a mechanism by which a session description is conveyed to users in a proactive fashion, i.e. the session description was not explicitly requested by the user.
Session advertisement: same as announcement.
Session description: A well-defined format for conveying sufficient information to discover and participate in a multimedia session.

A session is described by a series of attributes/value pairs, one per line. The attribute names are single characters, followed by = and a value. Optional values are specified with =*. Values are either an ASCII string or a sequence of specific types separated by spaces. Note that attribute names are only unique within the associated syntactic construct, i.e. within the Session, Time, or Media only.

A session border controller (SBC) is a session aware device used in some VoIP networks to exert control over the signaling and usually also the media streams involved in setting up, conducting and tearing down calls. SBCs are inserted into the signaling and/or media paths between calling and called parties or agents in a VoIP call, predominantly those using SIP, H.323, and MGCP call signaling protocols. Typically, the SBC modifies the stream of call control data involved in each call, perhaps limiting the kind of calls that can be conducted, changing the codec choices, and so on.

A few of the problem cases with the previously described SDPCapNeg protocols are
IMS—non-IMS interworking: A Non-IMS client may introduce extensions that are not supported in the IMS environment.
IMS version issue: Different IMS networks may be implemented to comply with different versions of the standard. Network A may accept e.g. media capabilities exchange while network B doesn't.

A known solution to this problem is that an IP Mobility Subsystem Call Session Control Function (IMS CSCF) or Session Border Gateway (SBG) can inspect and rewrite SDP's in the sense that unknown attributes or extensions are removed from the SDP. This may cause a number of problems however.

If one for instance consider the offer SDP below using the Media Capabilities [2] and the SDP for CS [3] extensions.

m=audio
a=creq:med−v0,ccap−v0
a=ccap:1 IN
a=ccap:2 PSTN
a=mcap:1 AMR
.
.
.
a=pcfg:1 m=1 c=2

A CSCF supports the media capabilities (indicated by the option tag “med-v0”) but it does not support the SDP for CS extension (indicated by the option tag “ccap-v0”) and the associated ccap attributes. The lines with the “a=ccap” attributes are therefore erased from the SDP.

Problem is however that on the “a=pcfg” line several capability attributes are referenced to form a potential configuration and as the referenced ccap attributes are removed the potential configuration becomes ambiguous.

This behavior can lead to severe problems, as several of the referenced attributes may be interconnected. For instance, a bandwidth attribute may only be relevant for a specific transport format and removal of one or many referenced attributes may cause potential configurations that are difficult or impossible to interpret by the recipient of the SDP.

Another example is the use of the “+” option on the “a=pcfg” line

m=audio
a=ccap:1 IN
a=ccap:2 PSTN
a=mcap:1 AMR
.
.
.
a=pcfg:1 +med−v0 +ccap−v0 m=1 c=2
a=pcfg:2 +med−v0 m=1

As with the previous example the “ccap-v0” option is not supported and the corresponding “a=ccap” attributes are removed as they are unknown. In this case the line “a=pcfg:1 +med-v0 +ccap-v0 m=1 c=2” becomes ambiguous.

The ambiguous potential configurations may, if not taken care of, cause unknown interoperability issues that may be problematic to resolve.

The basic concept of embodiment of the present invention is to implement an SDPCapNeg policy function in the CSCF's or SBG's (or similar intermediary device) that inspects the SDP and either rejects or modifies the SDP based on a list of supported extensions to the SDPCapNeg framework. The invention is not limited to IMS entities such as SBG or CSCF as it can be utilized e.g. by SBC's outside the IMS framework.

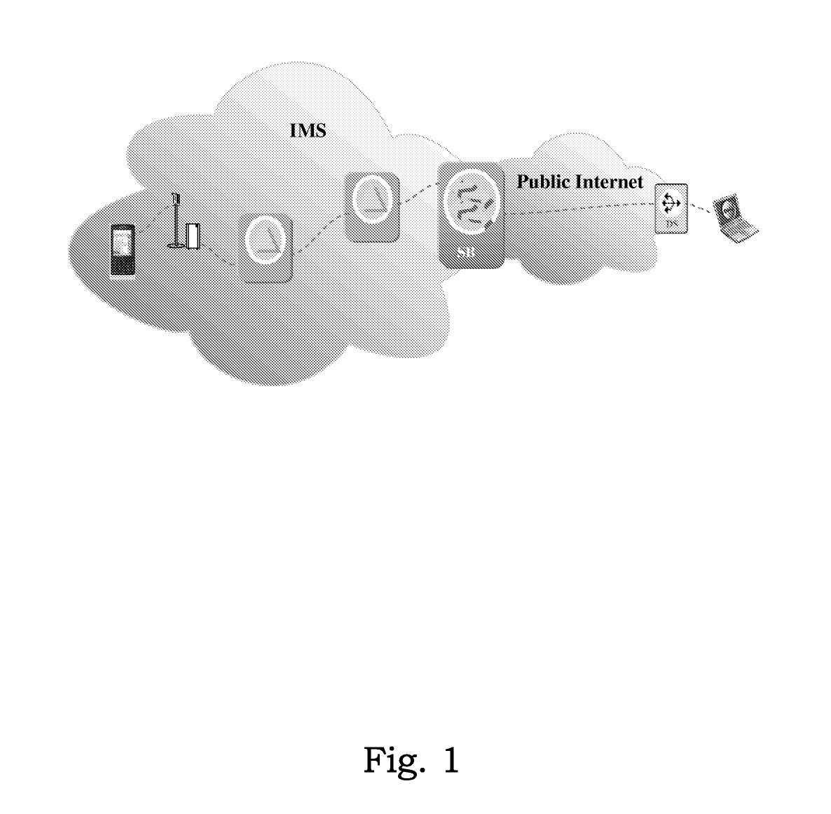

FIG. 1 outlines an IMS system that interconnects with a public internet via a session border gateway (SBG). The IMS contains a number of Call Session Control Functions (CSCF) over which the session setup signaling is forwarded. In this invention the CSCF and the SBG performs policing on the SDP that describes a session that is to be setup. The invention may however be applied to any node that does policing on session setup signaling.

In FIG. 1 a session is setup between a handheld device connected to an IMS network via a wireless 3GPP interface and a laptop connected to the public internet via a DSL connection.

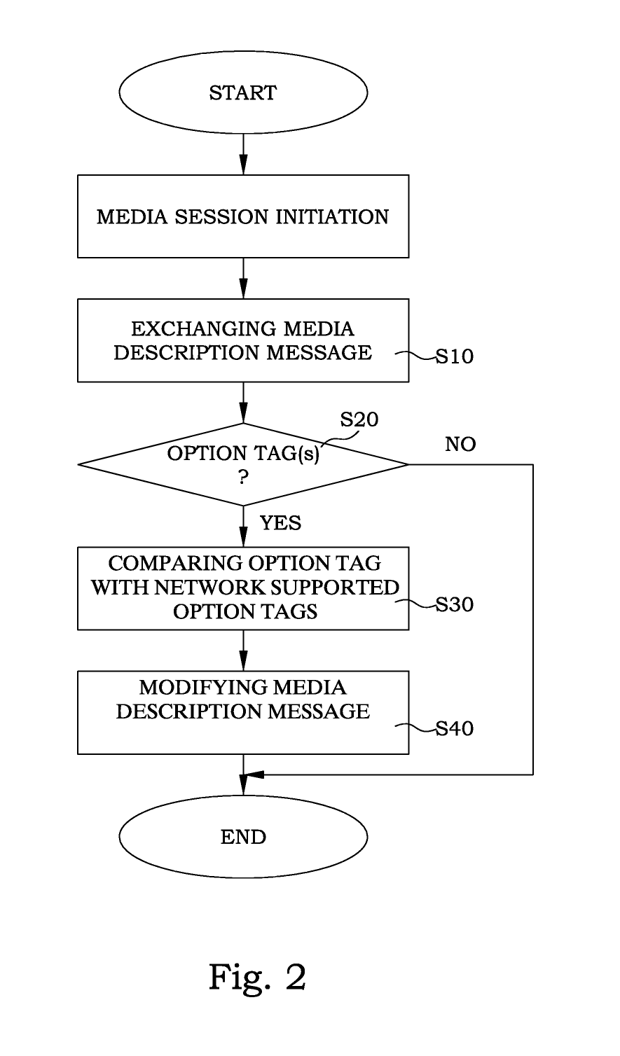

With reference to FIG. 2 a basic embodiment of the present invention will be described.

Consider the situation depicted in FIG. 1 where a media session is initiated between two user agents or participants, either directly or via an intermediate node. Initially a media session description message e.g. SDP is exchanged S10 between the two session participants. The media session description message is inspected and it is determined S20 if the message includes any option tags. The option tags indicate that certain functionality is necessary for understanding a potential configuration. The functionality is necessary at the end points e.g. at each participant, but can also be necessary in an intermediate node or nodes. Subsequently, any option tags present in the media session description are compared S30 to a set of network supported option tags. This is preferably enabled by maintaining a list or table of supported option tags in a node in the system. If there is a discrepancy between the determined option tags, and the listed option tags e.g. determined option tags are not present in the list, then the media session description message is modified to prevent ambiguous messages.

The step of modifying the media session description message is typically performed both for the session description part of the message and the media description part of the message.

According to a further embodiment of the invention the inspection and policing is performed in three steps:
1. On session level: If one or more unsupported option tags are given on session level then all potential and latent configurations are removed in the entire SDP.
2. For each media description:
   a) If one or more unsupported option tags are specified for a media description then all potential configurations are removed for the said media description.
   b) For each potential configuration in media description: If one or more unsupported option tags are specified then the potential configuration is removed.
3. For each latent configuration: If one or more unsupported option tags are specified then the potential configuration is removed.

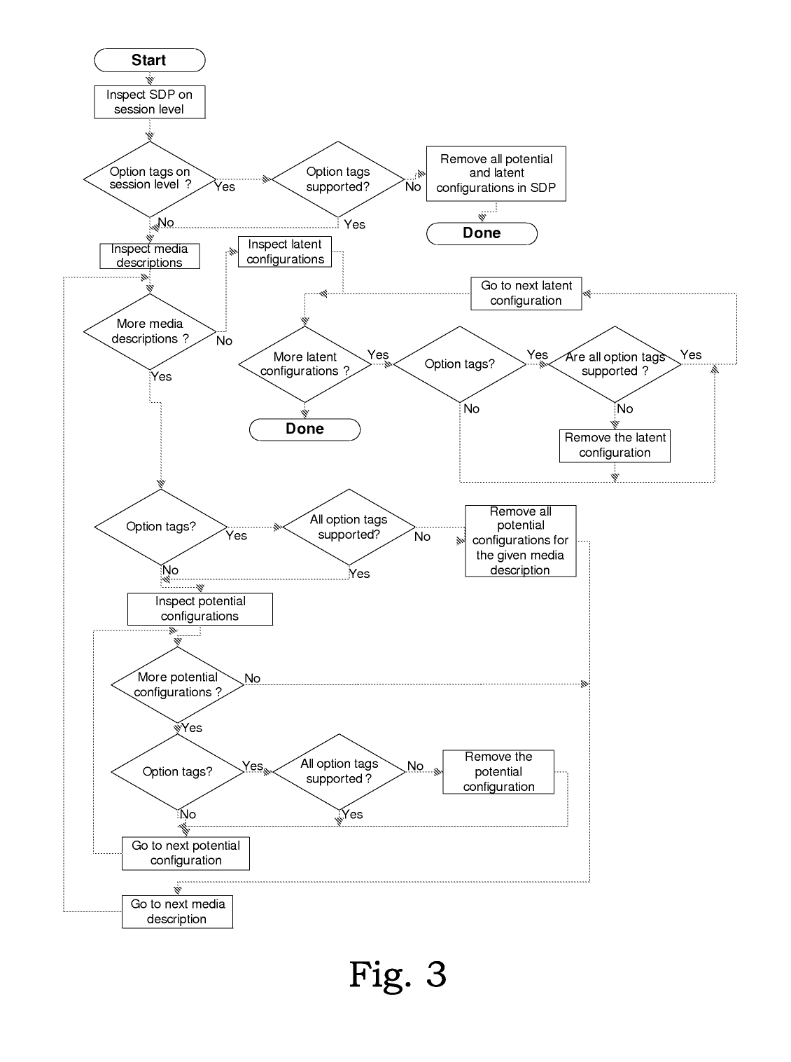

With reference to FIG. 3 a flow chart, illustrating a further embodiment of a flowchart of the invention will be described. The core aspect is still to inspect the SDP for the occurrence of option tags and remove potential and latent configurations which cannot be supported because they require support for extensions (as indicated by the option tags) that are not supported. The policy function as given by the flowchart can be implemented in any node (e.g. CSCF or SBG) that wish to do safe policing on SDPCapNeg SDP's.

In particular, extensions to the SDPCapNeg framework are required to specify the use of the extensions indicated by option tags using either the “a=creq” attribute or the “+” parameter on the “a=pcfg” line in the SDP. Moreover, support for SDPCapNeg extensions can be indicated by means of the “a=csup” option.

A policy function according to the embodiments of the present invention in e.g. the IMS SBG and/or CSCF should then inspect the SDP for such extensions and do the necessary policing on these.

SDPCapNeg [1] specifies how recipients of SDP should handle extensions that it does not understand.
[When an entity generates an SDP and it requires the recipient of that SDP to support one or more SDP Capability Negotiation extensions (except for the base) at the session or media level in order to properly process the SDP Capability Negotiation, the “a=creq” attribute MUST be included with option-tags that identify the required extensions at the session and/or media level. If support for an extension is needed only in one or more specific potential configurations, the potential configuration provides a way to indicate that instead (see Section 3.5.1.). Support for the basic negotiation framework is implied by the presence of an “a=pcfg” attribute (see Section 3.5.1.) and hence it is not required to include the “a=creq” attribute with the base option-tag (“cap-v0”).
A recipient that receives an SDP and does not support one or more of the required extensions listed in a “creq” attribute, MUST NOT perform the SDP Capability Negotiation defined in this document. For non-supported extensions provided at the session-level, this implies that SDP Capability Negotiation MUST NOT be performed at all. For non-supported extensions at the media-level, this implies that SDP
Capability Negotiation MUST NOT be performed for the media stream in question.]

The role of the policy function in a node (e.g. an SBG or a CSCF) in this invention is to remove parts of the SDP corresponding to extensions to SDPCapNeg that are not supported by the network.

The method can be best described in relation to the following exemplary embodiments:

Extensions Indicated by the a=creq Attribute

If the a=creq attribute is given on media level and this extensions is not supported by the network, the policy function will remove SDPCapNeg framework completely for the given media. In other words, all potential configurations are removed.

### Example

m=audio ...
a=fmtp...
a=rtpmap...
a=creq:med−v0
a=tcap:1 ...
...
a=pcfg:1 ...
a=pcfg:2 ...

The “med-v0” extension (media capabilities) is not supported; the consequence of this is that the entire SDPCapNeg framework is removed for the media. The SDP is then modified to become

m=audio ...
a=fmtp...
a=rtpmap...
a=creq:med−v0
a=tcap:1 ...

In other words the potential configurations are removed. Optionally the “a=creq” line can be removed as well.

If the unsupported option tag is specified on the “a=creq” line on session level then the potential and/or latent configurations would be removed from the entire SDP.

Extensions Indicated by the “+” Parameter on the “a=pcfg/” Lines

If the required extensions are indicated as option tags on the “a=pcfg” line(s), the role of the policy function is to remove the “a=pcfg” lines corresponding to SDPCapNeg extensions that are not supported.

### Example

m=audio ...
a=fmtp...
a=rtpmap...
a=tcap:1 ...
...
a=pcfg:1 +med−v0 ...
a=pcfg:2 ...

As with the previous example “med-v0” is not supported by the network, this means that the line “a=pcfg:1 +med-v0 . . . ” is removed from the SDP. The resulting SDP will then look like

m=audio ...
a=fmtp...
a=rtpmap...
a=tcap:1 ...
...
a=pcfg:2 ...

### Intelligent Design of SDP's

In order to exploit the embodiments of the present invention to its fullest degree and at the same time be backwards compatible against older IMS releases it is beneficial to create SDP's in a layered fashion in the sense that a few basic potential configurations, which do not require extensions to SDPCapNeg, are given.

According to a further embodiment, a SIP INVITE from UA A to UA B contains the SDP below

m=audio ...
a=fmtp...
a=rtpmap...
a=tcap:1 ...
...
a=pcfg:1 +med−v0 +ccap−v0 ...
a=pcfg:2 +med−v0 ...
a=pcfg:3 ...

A policy function in the home CSCF does not support the extension ccap-v0, therefore the corresponding “a=pcfg” line will be erased from the SDP with the resulting SDP below.

m=audio ...
a=fmtp...
a=rtpmap...
a=tcap:1 ...
...
a=pcfg:2 +med−v0 ...
a=pcfg:3 ...

It is fully possible that the network where UA B is located does not support med-v0. Thus the corresponding “a=pcfg” line will be erased as well with the resulting SDP.

m=audio ...
a=fmtp...
a=rtpmap...
a=tcap:1 ...
...
a=pcfg:3 ...

In other words, only the basic SDPCapNeg framework is supported in this case.

Later on as hardware and software in the IMS networks are updated, fewer potential configurations will potentially be removed from the SDP's. This will give the end user a more rich experience when allowed by the network and at the same time guarantee a predictable experience when one or many extensions are not allowed by the networks and therefore removed by the policing function described in this invention.

To illustrate the embodiments of the present invention, the interested reader is advised to look at an algorithm pseudo code in Appendix. The code gives a brief overview how the policy function might be implemented. It is syntactically similar to the flowchart of FIG. 3.

### List of Supported Extensions

A list of supported extensions to SDPCapNeg (a white list) needs to be maintained by the policy function in order to enable the comparison of the determined option tags and the supported option tags, the role of the policy function is then to see if the option tags determine in the SDP's are supported. As an example, this white list could look like Table 1 below.

TABLE 1

| 3GPP release | Supported extensions with option tags |
|---|---|
| 7 | {“cap-v0”} |
| 8 | {“cap-v0”, ”med-v0”} |
| 9 | {“cap-v0”, ”med-v0”, ”foo-bar”} |

Variants to the list may exist for instance due to local policy rules. For example, an operator may not wish the “foo-bar” extension to be used in his/her IMS network even though the equipment may support it, the removal policy may also be subject to billing issues.

### Rejection of SDP

Besides the above described modifying option there is a possibility to completely reject SDP's. In the reason string it is then beneficial to include which extensions that are not supported, and to reject any SDP that contains option tags indicative of unsupported extensions. This is implemented on session level, media level or both.

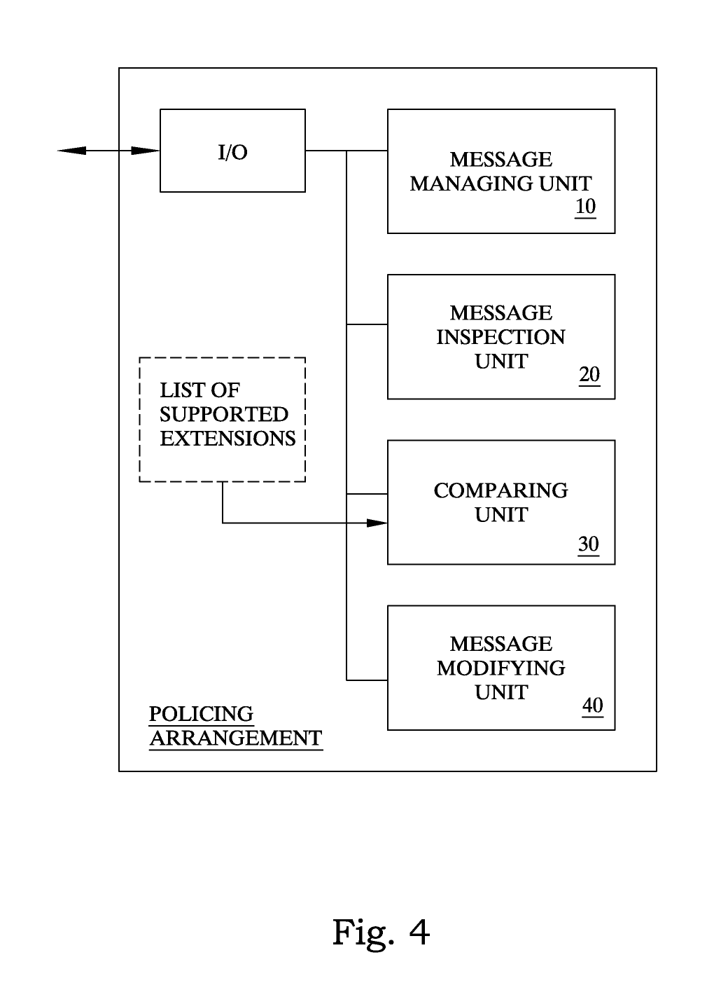

With reference to FIG. 4, an arrangement enabling the method according to the present invention is illustrated. The arrangement comprises well known means for handling of incoming and outgoing signals, which will not be described any further. In addition, the arrangement comprises a unit 10 for managing media session description messages between entities in a communication system. Managing in this sense is used to include processes such as receiving, transmitting, and relaying media session description messages. In addition, the arrangement includes a unit 20 for inspecting managed messages and determining if the messages include option tags or extensions/extension parameters indicative of potential configurations for the session. A comparing unit 30 is included to enable a comparison of any determined option tags with a list of option tags supported by the network as a whole or each individual participating user agent. Finally, the arrangement comprises a modifying unit 40 adapted to modify managed media session description messages based on the outcome of the comparison.

Specifically, the comparing unit 30 is further adapted to maintain and update a list of supported option tags in the system.

Some of the advantages of the invention include:
1. Uncontrolled additions of SDPCapNeg extensions made by UA efficiently avoided
2. Clear rules on how to deal with extensions→fewer problematic error cases.
3. The risk of ambiguous SDPCapNeg potential configurations avoided.
4. As IMS equipment is upgraded, more options will become available; giving a more rich experience for the user and still backwards compatibility is given to ensure a basic service in networks with limited support for SDPCapNeg extensions.
5. Reduced need to signal supported SDPCapNeg extensions to each UA at SIP-REGISTER. Something that is anyway difficult to synchronize if two UA's located in different IMS networks with different support for SDPCapNeg extensions wish to communicate.
6. Minimal extension capability database.

The proposed invention is recommended to be included in applicable parts in IMS networks to ensure secure use of SDPCapNeg and its extensions.

It needs to be stressed that the previously described SDP Capabilities Negotiation Framework and its extensions are currently a work in progress that means that names of attributes and option tags may change. The major design principle is however very unlikely to change.

It will be understood by those skilled in the art that various modifications and changes may be made to the present invention without departure from the scope thereof, which is defined by the appended claims.

### REFERENCES

[1] Andreasen, F., “SDP Capability Negotiation”, http://tools.ietf.org/wg/mmusic/draft-ietf-mmusic-sdp-capability-negotiation/ (work in progress), July 2008.
[2] Gilman. R, et. al., “SDP media capabilities Negotiation” http://tools.ietf.org/wg/mmusic/draft-ietf-mmusic-sdp-media-capabilities/ (work in progress), July 2008.
[3] M. Garcia-Martin, et al., “Miscellaneous Capabilities in SDP” http://tools.ietf.org/id/draft-garcia-mmusic-sdp-misc-cap-00.txt (work in progress), April 2008.
[4] The IETF RFC's listed below can be found at http://www.ietf.org.html.
[5] SDP “Session Description Protocol”, IETF, RFC4556
[6] SIP “Session Initiation Protocol”, IETF, RFC3261

### APPENDIX

### Algorithm Pseudo Code

The pseudo code below gives a brief overview how the policy function might work in a real implementation. This pseudo code is syntactically similar to the flowchart in FIG. 3.

function police_SDP ( )
{

// function that checks if unsupported

extensions

// to SDPCapNeg are specified and takes
// necessary actions when needed.
if (option tags on session level) {

// a=creq given on session level

// check if unsupported extension is
// specified

if (any of the option tags not supported)

{

remove all ”a=pcfg” lines in SDP
exit function
}

} else {

for each (media in SDP) {

if (option tags on media level) {

// a=creq given on media level

// check if unsupported extension

is

// specified

if (any of the option tags not

supported) {

remove all ”a=pcfg” lines for given

media

exit to next media
}

} else {

for each (potential configuration) {

// check if potential configuration

mandates

// unsupported extension by means

of ”+” option

// on pcfg line
if (”+” option specifies

unsupported

extension (s) indicated by

option tags) {

remove potential configuration

from SDP

}

}

}

}
for each (latent configuration) {

// check if latent configuration

mandates

// unsupported extension by means of

”+” option

// on pcfg line

if (”+” parameter specifies

unsupported

extension (s) indicated by

option tags) {

remove latent configuration from SDP
}

}

}

}

1-9. (canceled)

10. A method performed by a control node for managing media sessions between nodes in a telecommunication network, the method comprising:
exchanging a media session description message between two nodes, said media session description message describing a media session to be initiated between those nodes,
determining if said media session description message comprises at least one option tag that indicates extensions supporting potential configurations for said media session;
comparing said at least one option tag to a set of network supported option tags, said network supported option tags indicating supported extensions for said network; and
modifying said media session description message based on said comparison.

11. The method according to claim 10, wherein said modifying comprises removing potential configurations indicated by said at least one option tag if said at least one option tag does not correspond to said network supported option tags.

12. The method according to claim 11, wherein said media session description message comprises at least a session description part and a media description part.

13. The method according to claim 12, comprising performing said comparing and modifying for said session description part if said session description part comprises at least one option tag.

14. The method according to claim 13, comprising further performing said comparing and modifying for said media description part if said media description part comprises at least one option tag.

15. The method according to claim 10, further comprising maintaining and updating said set of network supported option tags in said control node.

16. The method according to claim 10, wherein a separate node maintains and updates said set of network supported option tags, and wherein the method further comprises receiving said set from the separate node in response to determining that said media session description message comprises at least one option tag.

17. A control node configured to manage media sessions between nodes in a telecommunication network, the control node comprising:
a message managing unit configured to manage a media session description message exchanged between two nodes, said media session description message describing a media session to be initiated between those nodes,
a message inspection unit configured to determine if said media session description message comprises at least one option tag that indicates extensions supporting potential configurations for said media session;
a comparing unit configured to compare said at least one option tag to a set of network supported option tags, said network supported option tags indicating supported extensions for said network; and
a message modifying unit configured to modify said media session description message based on said comparison.

18. The arrangement according to claim 17, wherein the comparing unit is configured to store said set of network supported option tags.

19. The arrangement according to claim 17, wherein said message modifying unit is configured to remove potential configurations indicated by said at least one option tag if said at least one option tag does not correspond to said network supported option tags.

20. The arrangement according to claim 19, wherein said media session description message comprises at least a session description part and a media description part.

21. The arrangement according to claim 20, wherein said comparing unit is configured to perform said comparing and said message modifying unit is configured to perform said modifying for said session description part if said session description part comprises at least one option tag.

22. The arrangement according to claim 21, wherein said comparing unit is configured to perform said comparing and said message modifying unit is configured to perform said modifying also for said media description part if said media description part comprises at least one option tag.

23. The arrangement according to claim 17, wherein a separate node maintains and updates said set of network supported option tags, and wherein the comparing unit is configured to receive said set from the separate node in response to the message inspection unit determining that said media session description message comprises at least one option tag.
